(19) United States
(12) Patent Application Publication
(10) Pub. No.: US 2015/0109527 A1
(43) Pub. Date: Apr. 23, 2015

(54) WAND FOR A WEARABLE ELECTRONIC DEVICE

(71) Applicants: Shant Tchakerian, Glendale, CA (US); Marineh Tchakerian, Glendale, CA (US)

(72) Inventors: Shant Tchakerian, Glendale, CA (US); Marineh Tchakerian, Glendale, CA (US)

(21) Appl. No.: 14/517,506

(22) Filed: Oct. 17, 2014

Related U.S. Application Data
(60) Provisional application No. 61/892,210, filed on Oct. 17, 2013.

(51) Int. Cl. H04N 5/225; H04N 5/232; G06F 3/041

(52) U.S. Cl. CPC H04N 5/2254; G06F 3/041; H04N 5/23219
USPC 348/376

(57) ABSTRACT

A wand and a portable electronic device. The wand includes a flexible substrate having a flat and a curled state and a mount attachable to a portable electronic device. The portable electronic device includes a mount attachable to the substrate. The substrate can enable the portable electronic device to become a wearable device. The substrate can include a sleeve that is attachable to the substrate. The substrate can be personalized by replacement of the sleeve with a different sleeve. The length of the substrate can be adjustable when in the flat state. The substrate can be rigid when in the flat state. The mount can communicatively and electrically couple the portable electronic device to the substrate, and the substrate can include at least one of an antenna, audio device, speaker, microphone, battery, solar panel, processor, memory, storage device, display device, user input device, networking device, and fingerprint sensor.

### CROSS REFERENCE TO RELATED APPLICATIONS

This application claims the benefit of U.S. Provisional Patent Application No. 61/892,210, entitled “WAND FOR A WEARABLE ELECTRONIC DEVICE,” filed Oct. 17, 2013, the disclosure of which is incorporated by reference herein in its entirety.

### FIELD

The present disclosure relates to wand that can be mounted to a portable electronic device.

### BACKGROUND

People often desire to take self-portraits, or photographs of groups of people that also include the camera operator. To accomplish this task, a camera operator typically has two options. In the first option, the camera operator can position the camera on a tripod or other stable surface, set an automatic timer, and then position themselves within the scene. In the second option, the camera operator holds the camera in front of them, aims the lens toward the camera operator (and any other people), and then presses the shutter button when the operator judges that they have aimed the lens such that the desired scene can be captured by the camera.

### SUMMARY

The inventor has encountered difficulty taking self-portraits, or photographs of groups of people that also include the camera operator. More precisely, when using an automatic timer, a tripod might not be readily available, and it might be difficult to position the camera such that the desired scene can be captured. Moreover, positioning the camera and setting the timer takes time, which can annoy and frustrate others posing for the photograph. When holding the camera, it might be difficult to aim the lens such that the desired scene can be captured by the camera.

The foregoing situation is addressed by a flexible wand that can be mounted to a portable electronic device.

Thus, in an example embodiment described herein, the wand includes a flexible substrate having a flat and a curled state and a mount constructed to be removably attachable to a portable electronic device.

Because the wand has a curled and a flat state, the wand can be easily carried when in the curled state, and in the flat state it can be used to position the portable electronic device, such as, for example, a camera, such that the desired scene can be captured.

According to an aspect, the wand enables a portable electronic device attached to the mount to become a wearable device.

According to an aspect, the substrate is a slap bracelet.

According to an aspect, the mount is constructed to communicatively couple the portable electronic device to the wand.

According to an aspect, when attached to the mount, the portable electronic device is powered on when the wand transitions from the curled state to the flat state, and the portable electronic device is powered off when the wand transitions from the flat state to the curled state.

According to an aspect, when attached to the mount, the portable electronic device is powered off when the wand transitions from the curled state to the flat state, and the portable electronic device is powered on when the wand transitions from the flat state to the curled state.

According to an aspect, the substrate includes a touch-sensitive sensor that provides a user-input to the portable electronic device when the portable electronic device is attached to the mount.

According to an aspect, the wand further comprises a sleeve that is removably attachable to the substrate.

According to an aspect, the wand is constructed to be personalized by replacement of the sleeve with a different sleeve.

According to an aspect, the substrate is constructed such that it provides a protective cover to the portable electronic device attached to the mount when the substrate is in the curled state.

According to an aspect, the length of the substrate is adjustable when in the flat state.

According to an aspect, the substrate is rigid when in the flat state.

According to an aspect, the portable electronic device is at least one of a digital watch, a smart watch, a digital camera, a video camera, a mobile phone, a mobile computer, a digital music player, and a personal digital assistant (PDA).

According to an aspect, the portable electronic device is constructed to acquire a user-designation of a number of faces, determine, by using face detection, whether the user-designated number of faces is included in a scene to be captured by an image capture device of the portable electronic device, provide a user-perceptible indicator that indicates a result of the determination, and responsive to a capture event, capture an image of the scene by using the image capture device, wherein the capture event is at least one of receipt of a user-instruction to capture an image of the scene, a determination that the user-designated number of faces is included in the scene, and an expiration of a timer.

According to an aspect, the portable electronic device is constructed to acquire a user-designation of a number of faces, determine, by using face detection, whether the user-designated number of faces is included in a scene to be captured by an image capture device of the portable electronic device, and responsive to a capture event, capture an image of the scene by using the image capture device, wherein the capture event is at least one of receipt of a user-instruction to capture an image of the scene, a determination that the user-designated number of faces is included in the scene, and an expiration of a timer.

According to an aspect, the mount is arranged at an end of the substrate.

According to an aspect, the mount is arranged on top of the substrate.

According to an aspect, the mount is adjustably arranged on the substrate, such that the position of the mount with respect to the substrate is adjustable.

According to an aspect, the wand is configured such that the mount is arranged at an end of the substrate in a case where the substrate is in the flat state, and the mount is arranged on top of an interior portion of the substrate in a case where the substrate is in the curled state.

According to an aspect, the substrate is a telescoping substrate such that the length of the substrate is adjustable when in the flat state by at least one of expanding the substrate or collapsing the substrate.

In an example embodiment, a portable device includes a mount constructed to be removably attachable to a flexible substrate having a flat and a curled state.

According to an aspect, the mount enables the portable electronic device attached to the substrate to become a wearable device.

According to an aspect, the substrate is a slap bracelet.

According to an aspect, the mount is constructed to communicatively couple the portable electronic device to the substrate.

According to an aspect, when attached to the substrate, the portable electronic device is powered on when the substrate transitions from the curled state to the flat state, and the portable electronic device is powered off when the substrate transitions from the flat state to the curled state.

According to an aspect, when attached to the mount, the portable electronic device is powered off when the substrate transitions from the curled state to the flat state, and the portable electronic device is powered on when the substrate transitions from the flat state to the curled state.

According to an aspect, the substrate includes a touch-sensitive sensor that provides a user-input to the portable electronic device when the portable electronic device is attached to the mount.

According to an aspect, the substrate further comprises a sleeve that is removably attachable to the substrate.

According to an aspect, the substrate is constructed to be personalized by replacement of the sleeve with a different sleeve.

According to an aspect, the substrate is constructed such that it protectively covers the portable electronic device when the substrate is attached to the mount and the substrate is in the curled state.

According to an aspect, the length of the substrate is adjustable when in the flat state.

According to an aspect, the substrate is rigid when in the flat state.

According to an aspect, the portable electronic device is at least one of a digital watch, a smart watch, a digital camera, a video camera, a mobile phone, a mobile computer, a digital music player, and a personal digital assistant (PDA).

According to an aspect, the portable electronic device is constructed to acquire a user-designation of a number of faces, determine, by using face detection, whether the user-designated number of faces is included in a scene to be captured by an image capture device of the portable electronic device, provide a user-perceptible indicator that indicates a result of the determination, and responsive to a capture event, capture an image of the scene by using the image capture device, wherein the capture event is at least one of receipt of a user-instruction to capture an image of the scene, a determination that the user-designated number of faces is included in the scene, and an expiration of a timer.

According to an aspect, the portable electronic device is constructed to acquire a user-designation of a number of faces, determine, by using face detection, whether the user-designated number of faces is included in a scene to be captured by an image capture device of the portable electronic device, and responsive to a capture event, capture an image of the scene by using the image capture device, wherein the capture event is at least one of receipt of a user-instruction to capture an image of the scene, a determination that the user-designated number of faces is included in the scene, and an expiration of a timer.

According to an aspect, the mount is constructed to attach to an end of the substrate.

According to an aspect, the mount is constructed to attach on top of the substrate.

According to an aspect, the mount is adjustably constructed to attach to the substrate, such that the position of the mount with respect to the substrate is adjustable.

According to an aspect, the mount is constructed such that the mount is arranged at an end of the substrate in a case where the substrate is in the flat state, and the mount is arranged on top of an interior portion of the substrate in a case where the substrate is in the curled state.

According to an aspect, the substrate is a telescoping substrate such that the length of the substrate is adjustable when in the flat state by at least one of expanding the substrate or collapsing the substrate.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a view of a wand attached to a portable electronic device according to an example embodiment.

FIG. 2 is a view of the wand of FIG. 1 showing the substrate in a flat state.

FIG. 3 is a view of the wand of FIG. 1 showing the substrate in a curled state, allowing the portable electronic device to be worn on a wrist.

FIG. 4 is a view showing the substrate of the wand of FIG. 1 used to position a portable electronic device such that a camera lens is aimed at the operator of the portable electronic device.

FIG. 5 is a detailed block diagram depicting the internal architecture of the portable electronic device of FIG. 1 according to an example embodiment.

FIG. 6 is a flow diagram for explaining processing performed by the portable electronic device of FIG. 1 according to an example embodiment.

### DETAILED DESCRIPTION

### First Embodiment

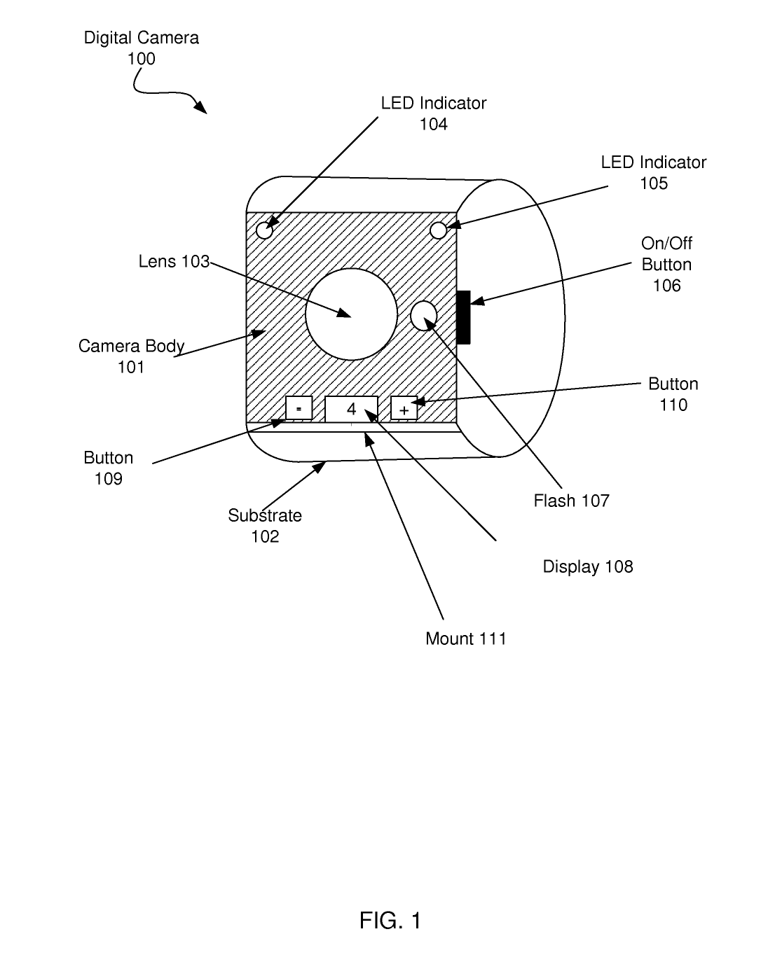

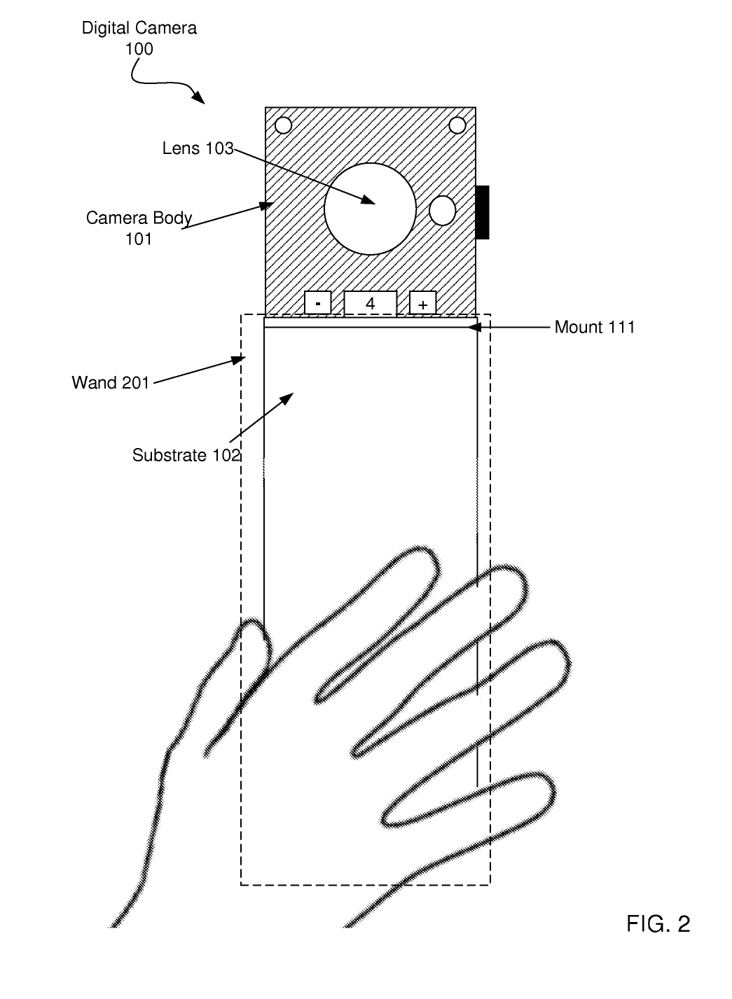

FIG. 1 is a view of the wand according to an example embodiment. As shown in FIG. 1, the wand (shown in more detail as 201 of FIG. 2) is comprised of a mount 111 and a substrate 102.

In the example embodiment, the mount 111 is removably attached to a portable electronic device 100 and integral to the wand. In some embodiments, the mount is removably attached to the substrate and removably attached to a portable electronic device. In some embodiments, the mount is integral to the portable electronic device and the mount is removably attached to the substrate. In some embodiments, the mount is integral to both the wand and the portable electronic device.

In the example embodiment, the mount 111 is arranged at an end of the substrate 102. In some embodiments, the mount is arranged on top of the substrate, at a position between the ends of the substrate. In some embodiments, the mount is adjustably arranged on the substrate, such that the position of the mount with respect to the substrate is adjustable. In some embodiments, the mount and the substrate are constructed such that the mount is arranged at an end of the substrate in a case where the substrate is in the flat state, and the mount is arranged on top of an interior portion of the substrate in a case where the substrate is in the curled state. In some embodiments, the substrate is a telescoping substrate such that the length of the substrate is adjustable when in the flat state by at least one of expanding the substrate or collapsing the substrate.

In the example embodiment, the portable electronic device 100 is a digital camera. In some embodiments, the portable electronic device can be any other type of portable electronic device, such as, for example, a digital watch, a smart watch, a digital camera, a video camera, a mobile phone, a mobile computer, a digital music player, and a personal digital assistant (PDA), a digital camera, a video camera, a mobile phone, a mobile computer, a digital music player, a personal digital assistant (PDA), and the like.

The digital camera 100 includes the following: a camera body 101, a lens 103, led indicators 104 and 105, a power button 106, a flash 107, a front-facing display 108, and buttons 109 and 110.

In the example embodiment, the mount 111 is constructed to communicatively and electrically couple a portable electronic device, such as digital camera 100, to the substrate 102. In the example embodiment, the substrate 102 includes a touch-sensitive sensor that provides a user-input to the portable electronic device, such as digital camera 100, when the portable electronic device is attached to the mount 111. In other example embodiments, the mount is constructed to communicatively couple a portable electronic device to the substrate 102 without also electrically coupling the portable electronic device to the substrate 102.

In some embodiments, the substrate 102 can include any other suitable type of component, such as, for example, an antenna, an audio device, a speaker, a microphone, a battery, a solar panel, a processor, a memory, a storage device, a display device, a user input device, a networking device, a fingerprint sensor, an RFID tag, and the like.

The wand includes a sleeve (not shown) that is removably attachable to the substrate 102. The wand is constructed to be personalized by replacement of the sleeve with a different sleeve.

In another example embodiment (not shown), the substrate is constructed such that it protectively covers the portable electronic device attached to the mount when the substrate is in the curled state.

The substrate 102 is rigid when in the flat state. In some embodiments, the substrate may or may not be rigid when in the flat state.

In the example embodiment, the digital camera 100 is a wearable digital camera, and the wand 201 is a wand that allows the digital camera 100 to be worn. The wand 201 has a flexible substrate 102 having a flat and a curled state. In the example embodiment, the flexible substrate 102 is a thin, bi-stable spring covered by fabric. In some embodiments, the bi-stable spring can be covered by any suitable material, such as, for example, plastic, fabric, rubber, and the like. A bi-stable spring is a spring having two equilibrium positions. An example flexible substrate having a bi-stable spring is the Slap Wrap brand bracelet, or generically, a slap bracelet. In some embodiments, the bi-stable spring is a telescoping bi-stable spring such that the length of the substrate is adjustable when in the flat state by at least one of expanding the telescoping bi-stable spring or collapsing the telescoping bi-stable spring.

The substrate 102 includes a touch-sensitive sensor that is operatively coupled with the image capture device of the digital camera 100, and which is constructed to receive a user-instruction to capture an image of a scene. In other words, in the example embodiment, the touch-sensitive sensor of the substrate 102 functions as the shutter button of the digital camera 100. In some embodiments, other input devices, sensors or buttons can function as the shutter button of the digital camera 100.

In some embodiments, a touch-sensitive sensor, other sensors, buttons, or any other suitable input device included in the substrate can provide any suitable type of user input to the portable electronic device, e.g., digital camera 100.

In the example embodiment, the digital camera 100 is powered on when the substrate 102 transitions from the curled state to the flat state, and the digital camera 100 is powered off when the substrate 102 transitions from the flat state to the curled state. In another example embodiment, the digital camera 100 is powered off when the substrate 102 transitions from the curled state to the flat state, and the digital camera 100 is powered on when the substrate 102 transitions from the flat state to the curled state.

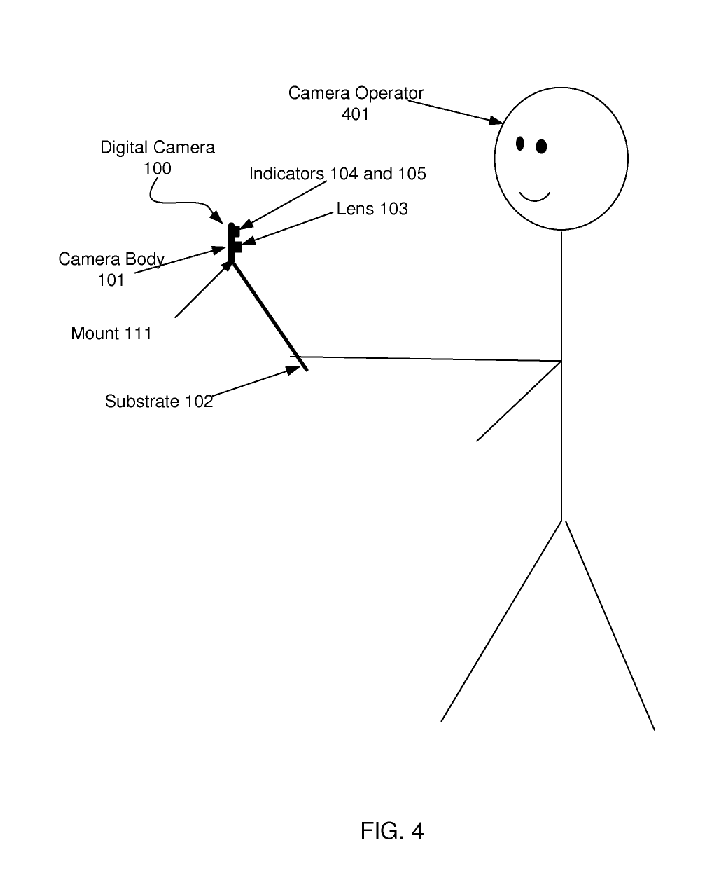

In the example embodiment, when the substrate 102 is in the flat state, the end of the substrate distal to the camera body 101 is constructed to receive a user-instruction to capture an image of a scene via the touch-sensitive sensor. As shown in FIG. 4, since the end of the substrate 102 furthest from the camera body 101 is constructed to operate as the shutter button, a camera operator 401 can use the substrate 102 as an extension wand to extend the camera body as far as possible from the body of the camera operator 401 while still being able to activate the shutter button. Using the mount 111, the camera operator can adjust the angle of the camera body 101 to capture the desired scene.

As shown in FIG. 1, the substrate and the mount of the wand enable a portable electronic device attached to the mount, such as the digital camera 100, to become a wearable device. In the example embodiment, the substrate is a slap bracelet.

In the example embodiment, buttons 109 and 110 are constructed to receive a user-designation of a number of faces. Specifically, the button 109 is constructed to receive a user-designation to decrease the number of faces, and the button 110 is constructed to receive a user-designation to increase the number of faces. The front-facing display 108 is constructed to display the user-designated number of faces.

In the example embodiment, the indicator 104 is a light emitting diode (LED) that functions as a user-perceptible indicator by emitting a green light to indicate that the user-designated number of faces is included in the scene. The indicator 105 is a light emitting diode (LED) that functions as a user-perceptible indicator by emitting a red light to indicate that the user-designated number of faces is not included in the scene. In other example embodiments, other colors can be emitted to provide the indications.

In some embodiments, the digital camera 100 includes a single indicator that emits light of different colors. For example, the single indicator can function as a user-perceptible indicator by emitting a green light to indicate that the user-designated number of faces is included in the scene, and it can also function as a user-perceptible indicator by emitting a red light to indicate that the user-designated number of faces is not included in the scene.

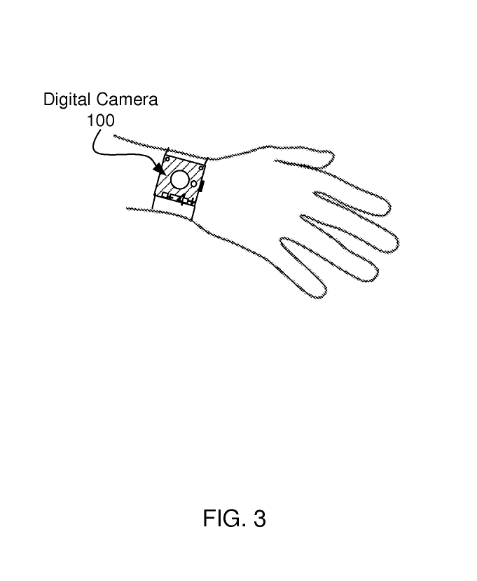

FIG. 2 is a view of the substrate 102 of the wand 201 in a flat state. FIG. 3 is a view of the substrate 102 of the wand 201 shown worn on a wrist.

FIG. 4 is a view showing the substrate of the wand used to position the digital camera 100 of FIG. 1 such that the lens 103 is aimed at the operator 401 of the camera. The digital camera 100 is constructed such that the user-perceptible indicators provided by indicators 104 and 105 are perceivable by the operator 401 of the camera in a case where the lens 103 is aimed at the operator 401 of the camera. In the example embodiment, the user-perceptible indicators are visual indicators. In some embodiments, the digital camera can provide any number of user-perceptible indicators which can be any visual indicator, audible indicator or combination of visual and audible indicators such that the indicator(s) can indicate whether or not the user-designated number of faces is included in the scene.

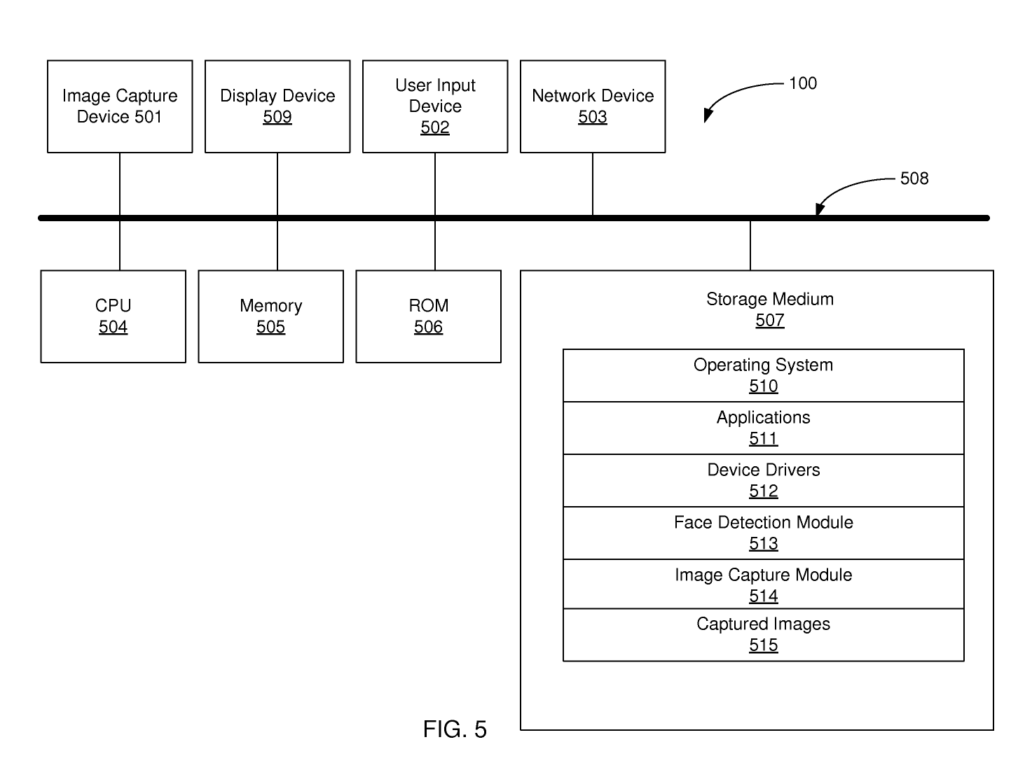

FIG. 5 is a detailed block diagram depicting the internal architecture of the digital camera 100 of FIG. 1 according to an example embodiment.

The bus 508 interfaces with a central processing unit (CPU) 504, a random access memory (RAM) 505, a read only memory (ROM) 506, a computer-readable storage medium 507, an image capture device 501, a display device 509, a user input device 502, and a network device 503.

The image capture device 501 captures a digital image of a scene via lens 103. The display device 509 controls the front-facing display 108 to display the user-designated number of faces, controls the indicator 104 to emit a green light to indicate that the user-designated number of faces is included in the scene, and controls the indicator 105 to emit a red light to indicate that the user-designated number of faces is not included in the scene.

As described above, in other example embodiments, other colors can be emitted to provide the indications. Also, in some embodiments, the digital camera 100 includes a single indicator that emits light of different colors. For example, the single indicator can function as a user-perceptible indicator by emitting a green light to indicate that the user-designated number of faces is included in the scene, and it can also function as a user-perceptible indicator by emitting a red light to indicate that the user-designated number of faces is not included in the scene.

The user input device 502 receives user-input from the buttons 109 and 110, from the touch-sensitive sensor of the substrate 102, and from the power button 106. The user input device 502 also powers on the digital camera when the substrate 102 transitions from the curled state to the flat state, and powers off the digital camera when the substrate 102 transitions from the flat state to the curled state.

The network device 503 provides one or more wired or wireless interfaces for exchanging data and commands between the digital camera 100 and other devices. Such wired and wireless interfaces include, for example, a Universal Serial Bus (USB) interface, blue tooth interface, Wi-Fi interface, Ethernet interface, Near Field Communication (NFC) interface, and the like.

In the example embodiment, the digital camera 100 is communicatively coupled with a portable electronic device via the network device 503. Example portable electronic devices include, for example, cell phones, Personal Digital Assistants, digital music players, digital watches, portable computers, and the like. In the example embodiment, when the digital camera 100 captures and image, the captured image is sent to the portable electronic device, and the portable electronic device displays the captured digital image so that it can be viewed. By virtue of this arrangement, the digital camera 100 does not need to include a display for displaying the captured image, but can instead use the display of the portable electronic device that is in communication with the digital camera 100.

The digital camera 100 can also exchange data and commands with the portable electronic device. For example, a user can interact with a user interface provided by the portable electronic device to configure the settings of the digital camera 100. By virtue of this arrangement, the digital camera 100 does not need to provide a user interface to configure the settings of the digital camera 100.

Machine-executable instructions in software programs (such as an operating system 510, application programs 511, and device drivers 512) are loaded into the memory 505 from the computer-readable storage medium 507, the ROM 506 or any other storage location. During execution of these software programs, the respective machine-executable instructions are accessed by the CPU 504 via the bus 508, and then executed by the CPU 504. Data used by the software programs are also stored in the memory 505, and such data is accessed by the CPU 504 during execution of the machine-executable instructions of the software programs.

The computer-readable storage medium 507 is a non-transitory computer-readable storage medium, such as, for example, a hard drive, a flash drive, a DVD, a CD, a flash storage, a solid state drive, and the like. The computer-readable storage medium 507 includes an operating system 510, the software programs 511, device drivers 512, a face detection module 513, image capture module 514, and captured images 515.

In the example embodiment, image capture module 514 includes machine-executable instructions for controlling the digital camera 100 to receive a user-designation of a number of faces via the user-input device 502 and determine whether the user-designated number of faces is included in a scene by using face detection module 513. Face detection module 513 is constructed to identify human faces in the scene. Unlike facial recognition, which compares an image of a target face with an image of a captured face to determine the identity of the person in the scene, face detection determines whether an object in the scene is a human face. Responsive to a determination that the user-designated number of faces is included in the scene, the instructions in image capture module 514 control the digital camera 100 to provide a user-perceptible indicator that indicates that the user-designated number of faces is included in the scene. Responsive to a determination that the user-designated number of faces is not included in the scene, the instructions in image capture module 514 control the digital camera 100 to provide a user-perceptible indicator that indicates that the user-designated number of faces is not included in the scene. Responsive to receipt of a user-instruction to capture an image of the scene, the instructions in image capture module 514 control the digital camera 100 to capture an image 515 of the scene by using the image capture device 501.

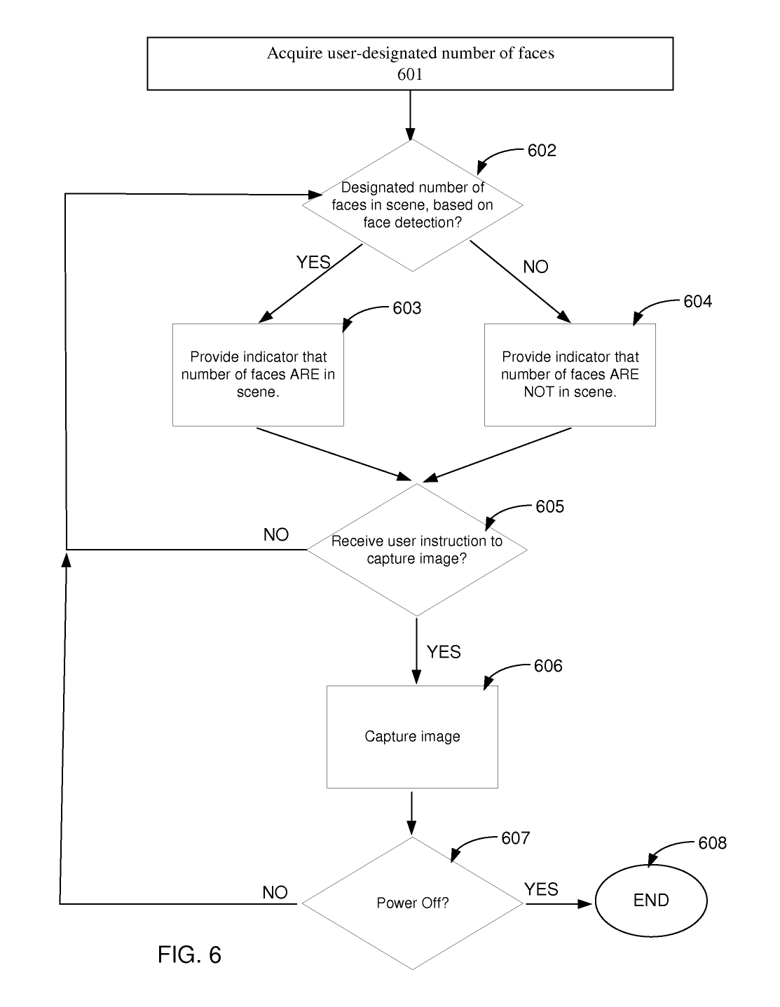

FIG. 6 is a flow diagram for explaining processing performed by the digital camera 100 of FIG. 1 according to an example embodiment. At 601, the image capture module 514 of FIG. 5 controls the digital camera 100 to acquire a user-designated number of faces, such as the number received via buttons 109 and 110.

At 602, the image capture module 514 controls the digital camera 100 to determine whether the user-designated number of faces is included in the scene by using face detection. In the example embodiment, the image capture module 514 controls the digital camera 100 to capture a pre-image of a scene, and the face detection module 513 performs face detection on the captured pre-image. The face detection performed by the face detection module 513 can be, for example, similar to the face detection technology presently available in digital cameras, such as, for example, digital cameras manufactured by Canon, Pentax, and FujiFilm. The face detection performed by the face detection module 513 analyzes the captured pre-image to find each object that has two eyes, a nose, ears and a chin. After analyzing the pre-image, the face detection module 513 determines the total number of faces detected in the pre-image. In some embodiments, any other suitable face detection can be used to identify the total number of faces detected in the pre-image.

After the total number of detected faces is determined, the image capture module 514 compares this number with the acquired user-designated number of faces to determine whether the user-designated number of faces is included in the scene.

If it is determined that the user-designated number of faces is included in the scene (“YES” at 602), then at 603 the image capture module 514 controls the display device 509 (of FIG. 5) to control the indicator 104 to emit a green light to indicate that the user-designated number of faces is included in the scene. Thereafter, processing proceeds to 605.

If it is determined that the user-designated number of faces is not included in the scene (“NO” at 602), then at 604 the image capture module 514 controls the display device 509 (of FIG. 5) to control the indicator 105 to emit a red light to indicate that the user-designated number of faces is not included in the scene. Thereafter, processing proceeds to 605.

As described above, in other example embodiments, other colors can be emitted to provide the indications. Also, in some embodiments, the digital camera 100 includes a single indicator that emits light of different colors. For example, the single indicator can function as a user-perceptible indicator by emitting a green light to indicate that the user-designated number of faces is included in the scene, and it can also function as a user-perceptible indicator by emitting a red light to indicate that the user-designated number of faces is not included in the scene.

In the example embodiment, the user-perceptible indicator is a visual indicator. In some embodiments, any visual indicator, audible indicator or combination of visual and audible indicators can be used to indicate that the user-designated number of faces is included in the scene and to indicate that the user-designated number of faces is not included in the scene.

At 605, the image capture module 514 determines whether a user-instruction to capture an image of the scene has been received. In the example embodiment, the user-instruction is received via the touch-sensitive sensor of the wand 102 and the user input device 502. If a user-instruction to capture an image of the scene has not been received (“NO” at 605), then processing returns to 602.

If a user-instruction to capture an image of the scene has been received (“YES” at 605), then processing proceeds to 606 where the image capture module 514 controls the image capture device 501 (FIG. 5) to capture an image of the scene. Thereafter processing proceeds to 607 where the image capture module 514 determines whether a power-off instruction has been received via the user input device 502 (FIG. 5). In the example embodiment, the power-off instruction is received from a user via the button 106 of FIG. 1. Additionally, when the wand 102 transitions from the flat state to the curled state, a power-off instruction is sent via user input device 502.

If a power-off instruction has been received (“YES” at 607), processing terminates at 608. If a power-off instruction has not been received (“NO” at 607), processing returns to 602.

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A wand comprising:
a flexible substrate having a flat and a curled state; and
a mount constructed to be removably attachable to a portable electronic device.

2. The wand of claim 1, wherein the mount is constructed to communicatively couple the portable electronic device to the wand.

3. The wand of claim 2, wherein the substrate includes a touch-sensitive sensor that provides a user-input to the portable electronic device when the portable electronic device is attached to the mount.

4. The wand of claim 1, wherein the wand further comprises a sleeve that is removably attachable to the substrate.

5. The wand of claim 1, wherein the length of the substrate is adjustable when in the flat state.

6. The wand of claim 1, wherein the substrate is rigid when in the flat state.

7. The wand of claim 1, wherein the portable electronic device is constructed to acquire a user-designation of a number of faces, determine, by using face detection, whether the user-designated number of faces is included in a scene to be captured by an image capture device of the portable electronic device, provide a user-perceptible indicator that indicates a result of the determination, and responsive to a capture event, capture an image of the scene by using the image capture device, wherein the capture event is at least one of receipt of a user-instruction to capture an image of the scene, a determination that the user-designated number of faces is included in the scene, and an expiration of a timer.

8. The wand of claim 1, wherein the portable electronic device is constructed to acquire a user-designation of a number of faces, determine, by using face detection, whether the user-designated number of faces is included in a scene to be captured by an image capture device of the portable electronic device, and responsive to a capture event, capture an image of the scene by using the image capture device, wherein the capture event is at least one of receipt of a user-instruction to capture an image of the scene, a determination that the user-designated number of faces is included in the scene, and an expiration of a timer.

9. The wand of claim 6, wherein the substrate is a telescoping substrate such that the length of the substrate is adjustable when in the flat state by at least one of expanding the substrate or collapsing the substrate.

10. A portable electronic device comprising:
a mount constructed to be removably attachable to a flexible substrate having a flat and a curled state.

11. The portable electronic device of claim 10, wherein the mount is constructed to communicatively couple the portable electronic device to the substrate.

12. The portable electronic device of claim 11, wherein the substrate includes a touch-sensitive sensor that provides a user-input to the portable electronic device when the portable electronic device is attached to the mount.

13. The portable electronic device of claim 10, wherein the substrate further comprises a sleeve that is removably attachable to the substrate.

14. The portable electronic device of claim 21, wherein the length of the substrate is adjustable when in the flat state.

15. The portable electronic device of claim 21, wherein the substrate is rigid when in the flat state.

16. The portable electronic device of claim 21, wherein the portable electronic device is constructed to acquire a user-designation of a number of faces, determine, by using face detection, whether the user-designated number of faces is included in a scene to be captured by an image capture device of the portable electronic device, provide a user-perceptible indicator that indicates a result of the determination, and responsive to a capture event, capture an image of the scene by using the image capture device, wherein the capture event is at least one of receipt of a user-instruction to capture an image of the scene, a determination that the user-designated number of faces is included in the scene, and an expiration of a timer.

17. The portable electronic device of claim 21, wherein the portable electronic device is constructed to acquire a user-designation of a number of faces, determine, by using face detection, whether the user-designated number of faces is included in a scene to be captured by an image capture device of the portable electronic device, and responsive to a capture event, capture an image of the scene by using the image capture device, wherein the capture event is at least one of receipt of a user-instruction to capture an image of the scene, a determination that the user-designated number of faces is included in the scene, and an expiration of a timer.

18. The portable electronic device of claim 14, wherein the substrate is a telescoping substrate such that the length of the substrate is adjustable when in the flat state by at least one of expanding the substrate or collapsing the substrate.
